(19) United States
(12) Patent Application Publication
(10) Pub. No.: US 2006/0009959 A1
(43) Pub. Date: Jan. 12, 2006

(54) Activity factor based design

(76) Inventors: Timothy C. Fischer, Berthoud, CO (US); Rohit Bhatia, Fort Collins, CO (US)

Correspondence Address: HEWLETT-PACKARD COMPANY;Intellectual Property Administration, P.O. BOX 272400, Fort Collins, CO, 80527-2400, US

(21) Appl. No.: 11/089,588

(22) Filed: Jul. 7, 2004

(51) Int. Cl. G06F 17/50

(52) U.S. Cl. 703/18

(57) ABSTRACT

Systems, methodologies, media, and other embodiments associated with activity factor based design are described. One exemplary system embodiment includes an activity factor logic configured to determine an activity factor for a first node. The activity factor relates an input activity for the first node to an output activity for the first node. The example system may also include a transmission factor logic configured to determine a transmission factor for the first node. The transmission factor describes a degree of causal power switching between the first node and a second node. The example system may also include a downstream power logic operably connected to the activity factor logic or the transmission factor logic. The downstream power logic may be configured to determine a power consumption amount for the second node. The power consumption amount may depend, for example, on the activity factor and the transmission factor.

### BACKGROUND

Issues associated with integrated circuit power consumption continue to grow. For example, higher power consumption may elevate chip temperatures and lead to circuit performance degradation and decreased circuit lifetime. Both the number of transistors in circuits and the frequency at which circuits are clocked are increasing while the voltage applied to circuits is dropping. However, voltage is not dropping as quickly as power is increasing, leading to hotter chips. Thus, power consumption continues to be a design concern, particularly in digital CMOS (complimentary metal oxide semiconductor) circuits.

Mobile computing platforms may have severely restricted power budgets. Untoward power consumption in some integrated circuits may discourage their use in mobile computing platforms. Thus, some designers address maximizing computing performance in a minimal system footprint that may be constrained by a restricted power budget. Therefore, efforts continue towards developing design tools that work with circuit simulators to more accurately and more efficiently estimate power consumption.

Designers may treat a transistor as a basic functional element in a digital circuit design. Additionally, and/or alternatively, designers may treat gates or cells as basic functional elements. A cell may contain a collection of transistors that are connected into an electrical circuit. Cell inputs and outputs may be referred to as pins, and the interconnections between cells may be referred to as nets. Various data structures, maps, diagrams, and so on, may be used to describe these circuits. For example, a netlist may include information concerning the connections between cell pins. A combinational portion of a logic circuit may be represented as a Boolean network like a directed acyclic graph where a node may represent a single-output logic function and an edge may represent a dependency between an input and an output on corresponding logic functions.

CMOS semiconductors include NMOS (negative channel metal oxide semiconductor) negative polarity circuits and PMOS (positive channel metal oxide semiconductor) positive polarity circuits. Since either an NMOS or a PMOS circuit is active in a node at a point in time, CMOS based designs may consume less power than designs based on a single transistor type. CMOS circuit inputs may be in one of four states. The four states include being held at a high voltage, being held at a low voltage, transitioning from a high voltage to a low voltage, and transitioning from a low voltage to a high voltage. Dynamic power consumption occurs when a circuit is active, that is when cell outputs and/or internal nodes transition from one voltage level to another. Thus, power-consumption in digital CMOS circuits is highly dependant on circuit switching activity.

Power consumption in digital CMOS circuits can be viewed as being the sum of three different consumptions: static power consumption, short-circuit power consumption, and dynamic power consumption. Dynamic power consumption is the most significant component and may account, for example, for seventy-five percent of power consumption or more. Dynamic power consumption for a CMOS gate can be modeled by:
P=C×V²×F×AF (1)
where P=dynamic power consumption, C=switched capacitance, V=switching voltage, F=switching frequency, and AF=activity factor.

As noted above, dynamic power consumption is related to the charging and discharging capacitances associated with a CMOS circuit. Equation (1) illustrates that the dynamic power consumption component attributable to charging and discharging capacitances is proportional to the product of capacitance times the charge and discharge rate times the square of the voltage. Equation (1) also illustrates that dynamic power consumption in digital CMOS circuits depends linearly on switching activity.

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system for analyzing a portion of a circuit using a causal power switching based approach.

FIG. 2 illustrates another example system for analyzing a portion of a circuit using a causal power switching based approach.

FIG. 3 illustrates an example method for analyzing a portion of a circuit using a causal power switching based approach.

FIG. 4 illustrates another example method for analyzing a portion of a circuit using a causal power switching based approach.

FIG. 5 illustrates an example computing environment in which example systems and methods illustrated herein can operate.

FIG. 6 illustrates an example data packet.

FIG. 7 illustrates example subfields within the example data packet.

FIG. 8 illustrates an example application programming interface (API).

FIG. 9 illustrates an example method associated with a graphical user interface (GUI).

### DETAILED DESCRIPTION

Much research has been focused on reducing power consumption in digital CMOS circuits by reducing switching capacitance. However, examining an activity factor for an upstream node and attributing causal power switching in related downstream nodes to the upstream node facilitates modeling what effect, if any, changing an upstream node will have on downstream power consumption in nodes in the fanout of the upstream node. For example, while the power for a single node can be computed according to:
P=C×V²×F×AF (1)
the power for a set of nodes in a fanout of another node can be computed according to:

$${P}_{Net} = {\sum }_{i = 1}^{i = NumNodes} {C}_{i} \times {V}^{2} \times F \times {AF}_{i} \qquad ( 2 )$$

Furthermore, degrees of causal connectivity can be modeled according to:
P=C×V²×F×AF×TF (3)
where TF is a transmission factor. The transmission factor (TF) may describe the dynamic switching power caused in downstream nodes as a result of, an in relation to, units of dynamic switching power in the upstream node. The TF may be, for example, a ratio of an output activity factor to an input activity factor. Thus, it is to be appreciated, that the TF may be a real number that is less than, equal to, or greater than 1.0.

Example systems and methods described herein concern causal power switching analysis in integrated circuit design. Example systems and methods may calculate a causal switching power between nodes by relating an activity factor for an upstream node to a downstream power consumption in a fanout of nodes related to the upstream node. The activity factor is a relationship of activity within a node (e.g., between input line and output line). The activity factor may be computed by simulating node behavior with a set of input vectors and watching the resulting output activity. Thus, the activity factor concerns how often out of N cycles a certain node switches high/low or low/high. In one example, a designer can make design decisions based on potential downstream power consumption changes due to changing the activity factor for that certain node and/or for an upstream node.

Example systems and methods thus concern understanding how activity on one node relates to activity on another node(s). Once the activity relationships are understood, design changes can be proposed to reduce power requirements. The design changes can be tested without physically implementing the change and without requiring a resimulation of the circuit.

Conventionally, power estimation tools have not collected and/or reported power for nodes related by connectivity or logical behavior. Conventional tools have not calculated how much downstream power consumption is due to switching activity propagating from an upstream component. But information concerning propagated switching activity and causally related switching power can be captured. This information can facilitate estimating the effect of a local activity factor change on a portion of a circuit without requiring physical implementation of a proposed design change and without requiring a resimulation of the switching behavior for the entire circuit. Furthermore, the information can facilitate finding candidate nodes for gating (turning off) downstream power without requiring a resimulation of the switching behavior for the entire circuit.

Cells may be connected in nets. Downstream nodes connected to the selected node are said to be in the selected node's fanout. Downstream nodes residing the same number of gate delays from the selected node are said to be located at the same “fanout level”. For a net, switching power comes from current that flows to and/or discharges nets that connect cells.

One example method for performing causal power switching analysis includes selecting an initial node to be analyzed. The activity factor for that node can then be acquired. In one example, the activity factor may be read from a data store while in another example the activity factor may be computed. Computing the activity factor may include running a simulation and comparing node inputs to node outputs. After acquiring the activity factor, the power consumption for that node can be computed. While the power consumption for that single node is interesting, the downstream power consumption associated with and related to that node may be more interesting.

Thus, an example method may include traversing a circuit netlist to identify the nodes that are downstream from the node. The nodes may be analyzed, for example, individually, collectively, by fanout levels, and so on. Analyzing the downstream nodes, individually and/or in some aggregate form facilitates identifying candidate power consumption control locations. These candidate power consumption control locations may be nodes with a high leverage in the circuit for reducing power.

In one example, a complete causality relationship is assumed between upstream and downstream nodes. This causality relationship can be modeled by adding a transmission factor term to a downstream power consumption equation. The transmission factor can also model less than perfect attribution between an action at an upstream node and a result at a downstream node(s). In one example, a transmission factor equal to one assumes complete causality or perfect attribution between upstream and downstream nodes while in another example a transmission factor less than or equal to one assumes less than perfect causality.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that causes a computer, processor, or other electronic device to perform functions, actions and/or behave in a desired manner. The instructions may be embodied in various forms like routines, algorithms, modules, methods, threads, and/or programs including separate applications or code from dynamically and/or statically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

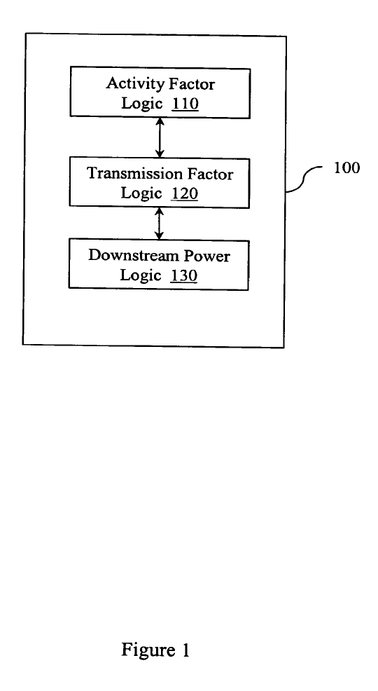

FIG. 1 illustrates a system 100 for analyzing a portion of a circuit using a causal power switching based approach. The system 100 includes an activity factor logic 110 that is configured to determine an activity factor for a first node. In general, from one perspective, activity factor relates input activity for a first node to output activity for the first node. For example, if the node includes data input lines and a logic operation output line, the activity factor relates how often an average set of inputs will cause the output line to be active. It is to be appreciated that a node, as that term is used herein, refers to a design-level element of a digital CMOS integrated circuit. A node may take forms including, but not limited to, a gate, a cell, and so on. In one example, the activity factor may be the ratio of node switches per a unit of time for a given set of inputs to the circuit driving a node. Thus, the activity factor may be viewed as a ratio of switches between two signals (e.g., clock, target node).

In one example, the activity factor logic 110 may determine the activity factor for the first node by analyzing the results of a circuit simulation. The circuit simulation may simulate the first node and results produced by that first node. For example, the circuit simulation may include presenting a set of input vectors to the first node, acquiring a set of output vectors produced by the circuit simulation in response to the set of input vectors being presented to the first node, and analyzing the output vectors. Thus, output activity for the first node may be related to input activity and the activity factor determined. In another example, the activity factor logic 110 may acquire the activity factor from a data store in which a set of node activity factors are stored.

The system 100 may also include a transmission factor logic 120 that is configured to determine a transmission factor for the first node. The transmission factor describes a degree of causal power switching between the first node and a second node (e.g., a downstream node). For example, if a downstream node experiences switching activity every time a related upstream node experiences switching activity, then the transmission factor between the nodes may be one hundred percent. However, if the downstream node experiences switching activity only every other time a related upstream node experiences switching activity, then the transmission factor between the nodes may be fifty percent.

The system 100 may also include a downstream power logic 130 that is operably connectable to the activity factor logic 110 or the transmission factor logic 120. The downstream power logic 130 may be configured to determine a power consumption amount for the second node. The power consumption amount may depend, for example, on the activity factor and the transmission factor. By way of illustration, the power consumption for a downstream node may be computed according to:
P=C×V²×F×AF×TF (3)
where P=power consumption amount, C=capacitance, V=voltage, F=switching frequency, AF=activity factor, and TF=transmission factor. When there is a one-to-one relation between upstream switching activity and downstream switching activity, the transmission factor (TF) may be set to one (representing 100% causal power switching). In one example, when there may not be a one-to-one relation between upstream switching activity and downstream switching activity, the TF may be set to a value less than one, representing less than complete causal power switching. In one example, when TF is assumed to equal one, the power consumption equation (3) can be reduced to:
   P=C×V²×F×AF (1)

In another example, when there may not be a one-to-one relation between upstream switching activity and downstream switching activity, the TF may be set to a value greater than one, representing, for example, an occurrence of an “activity generating circuit” that multiplies activity.

In one example, the downstream power logic 130 may compute a fanout power consumption amount attributable to the first node. The fanout power consumption may be determined by traversing a set of nodes in a netlist. The nodes are located downstream from the first node and the netlist may be stored, for example in a data store (not illustrated) that can be accessed by the system 100. Calculating the fanout power consumption may include calculating a power consumption amount for nodes in the netlist and summing the calculated power consumption amounts. The fanout power consumption amount may be determined, for example, for an individual member of the set of nodes in the netlist, for a subset of nodes representing a fanout level, for the entire set of nodes in the netlist, and so on.

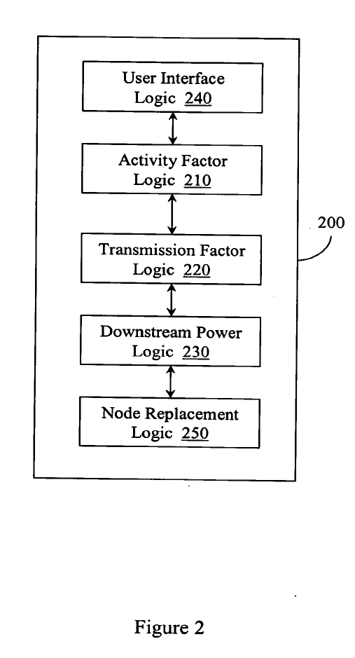

FIG. 2 illustrates an example system 200 for analyzing a portion of a circuit using a causal power switching based approach. The system 200 includes an activity factor logic 210, a transmission factor logic 220, and a downstream power logic 230 similar to those described in association with system 100 (FIG. 1). Additionally, the system 200 may also include a user interface logic 240 that is operably connected to the activity factor logic 210. The user interface logic 240 may be configured to facilitate selecting a node for which the activity factor logic 210 will determine an activity factor and thus for which a downstream fanout power consumption will be determined. Thus, the node may also be treated as the root node for transmission factor calculations. While a user interface logic 240 is illustrated, in another example, the system 200 may receive an input concerning which node to analyze from, for example, an artificial intelligence logic, an integrated circuit design tool, and so on.

In one example, the system 200 may also include a node replacement logic 250 that is configured to select a node to be reconfigured in a circuit including a set of nodes. Whether a node can be replaced may depend on the availability of another node with a different activity factor. Whether the node is replaced may depend on factors like the activity factor of a first node and a replacement node, the power consumption amount attributable to the first node and the replacement node, and the potential change in the power consumption amount that is attributable to reconfiguring circuit by replacing the first node with the replacement node. While physically replacing the first node is described, it is to be appreciated that the first node may be logically replaced by reconfiguring its activity factor.

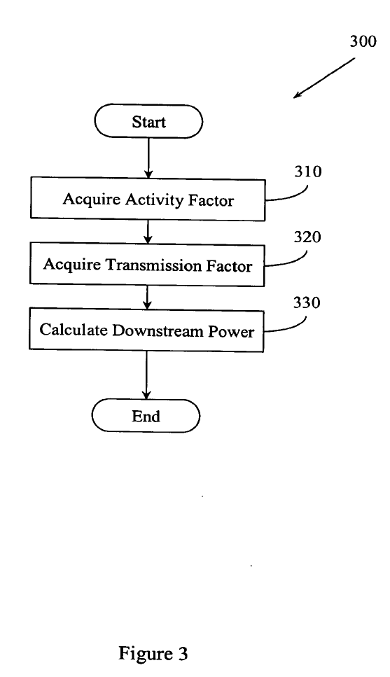

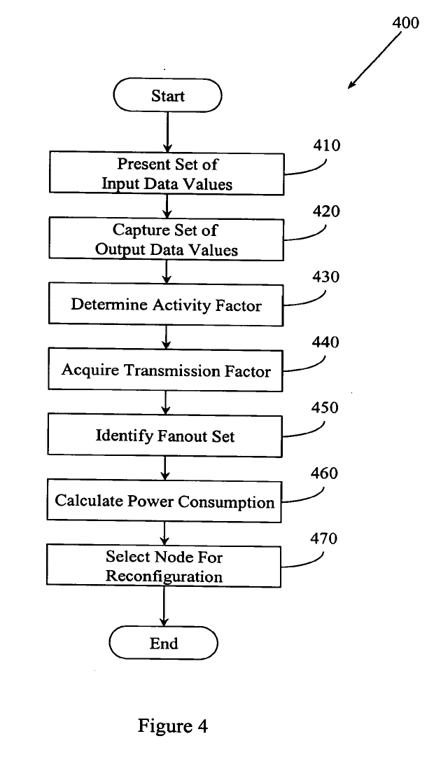

Example methods may be better appreciated with reference to the flow diagrams of FIGS. 3 and 4. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagrams, blocks denote “processing blocks” that may be implemented with logic. The processing blocks may represent a method step and/or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 3 illustrates a method 300 for analyzing a portion of a circuit using a causal power switching based approach. The method 300 includes, at 310, acquiring an activity factor for a node in a digital CMOS circuit. Acquiring the activity factor for the node in the digital CMOS circuit may include computing the activity factor. Computing the activity factor may include, for example, presenting a set of input data values to a circuit simulation that includes the node, analyzing a set of output data values produced in response to the set of input data values being presented to the node in the circuit simulation and determining the activity factor as a relationship between the set of input data values and the set of output data values. For example, if a node output transitions every time a node input transitions, then the activity factor may be one hundred percent. However, if a node output transitions only every fourth time a node input transitions, then the activity factor may be twenty-five percent. In another example, acquiring the activity factor may include reading it from a data store.

The method 300 may also include, at 320, acquiring a transmission factor that models a causal power switching relationship between the node and a set of downstream nodes related to the node. Acquiring the transmission factor may include, for example, reading a transmission factor from a data store, receiving a transmission factor from an integrated circuit design tool, computing the transmission factor during a simulation, and so on.

The method 300 may also include, at 330, calculating a downstream power consumption for a subset of the set of downstream nodes. The downstream power consumption is attributable to power switching associated with the node to the degree accounted for by the transmission factor. Thus, the downstream power consumption depends, at least in part, on the activity factor and the transmission factor. In one example, calculating the downstream power consumption may include identifying a set of nodes located in a downstream fanout associated with the node, calculating a power consumption for a subset of the set of nodes, and aggregating the power consumptions calculated for the subset. Aggregating the power consumptions may include, for example, summing the power consumptions, averaging the power consumptions, or performing some other mathematical function on the power consumptions.

In different examples, the downstream nodes may be analyzed in other manners. For example, individual members of the set of nodes may be analyzed, a subset of nodes representing a fanout level may be analyzed, the entire set of nodes may be analyzed, and so on. In one example, the power consumption for a member of the set of nodes is calculated according to:
P=C×V²×F×AF×TF (3)
where P=power consumption amount, C=capacitance, V=voltage, F=switching frequency, AF=activity factor, and TF=transmission factor. If there is perfect attribution between the upstream node switching activity and downstream node switching activity, then TF may be set to one, representing one hundred percent attribution. If there is less than perfect attribution, then TF may be set to less than one, representing less than one hundred percent attribution. In some cases, TF may be greater than one since TF may be the ratio of output activity factor to input activity factor.

As described above, a power P₁ for a first circuit may be computed according to:
P₁=C₁×V²×F×AF₁ (4)

Thus, for a second circuit, where a node has been change and AF₂ is known, the power P₂ may be computed according to:
P₂=C₂×V²×F×AF₂ (5)

But if AF₂ is not already known, then the power P₂ may be computed according to:
P₂=C₂×V²×F×TF_{1, 2} (6)
where TF_{1, 2} is the transmission factor of AF₁ from node₁ to node₂.

It is to be appreciated that summation equation (2) could also include similar TF_{i, j} substitutions.

While FIG. 3 illustrates various actions occurring in serial, it is to be appreciated that various actions illustrated in FIG. 3 could occur substantially in parallel. By way of illustration, a first process could acquire an activity factor. Similarly, a second process could acquire a transmission factor while a third process could compute a downstream power consumption. While three processes are described, it is to be appreciated that a greater and/or lesser number of processes could be employed and that lightweight processes, regular processes, threads, and other approaches could be employed. It is to be appreciated that other example methods may, in some cases, also include actions that occur substantially in parallel.

FIG. 4 illustrates a method 400 for analyzing a portion of a circuit using a causal power switching based approach. The method 400 may include, at 410, presenting a set of input data values to a circuit simulation, and, at 420, capturing a set of output data values. The data values may be produced by a simulation that includes the first node. With the input data values and the output data values available, the method 400 may, at 430, determine an activity factor for a node. While a single node is described, it is to be appreciated that in some examples activity factors may be computed for a set of nodes and that the nodes may be causal power switch analyzed individually, collectively, in subsets, and so on.

The method 400 may also include, (not illustrated), selecting a node for causal power switching related activity factor analysis based on an input received via a user interface, an input received from an artificial intelligence logic, and so on.

Having selected a node for analysis, the method 400 may proceed, at 440, to acquire a transmission factor that relates the node to a set of downstream nodes. The set of downstream nodes, the fanout from the node, may be identified at 450 and thus, at 460, power consumption in that fanout may be computed. Identifying the fanout set at 450 may include, for example, accessing and traversing a netlist. The power consumption may be calculated at 460 using, for example, equations (1), through (6).

The method 400 may also include, at 470, selecting a node in the digital CMOS circuit for reconfiguration based, for example, on the computed power consumption in the fanout and the availability of a replacement node having an activity factor different than the activity factor associated with the node.

In one example, the method 400 may also include, (not illustrated), calculating a second downstream power consumption for the subset of downstream nodes using the replacement node and selectively replacing the node in the digital CMOS circuit with the replacement node. Whether the node is replaced with the replacement node may be based on a relationship between the first downstream power consumption and the second downstream power consumption. For example, if the second downstream power consumption is less than the first downstream power consumption by an amount that exceeds a threshold (e.g., twenty percent), then the node may be replaced. The threshold may be, for example, a pre-configured, dynamically updateable threshold, may be decided in an ad hoc manner by a user, and so on.

In one example, methodologies are implemented as processor executable instructions and/or operations stored on a computer-readable medium. Thus, in one example, a computer-readable medium may store processor executable instructions operable to perform a method that includes acquiring an activity factor for a node in a circuit, acquiring a transmission factor that models a causal power switching relationship between the node and a set of downstream nodes related to the node, and calculating a first downstream power consumption for a subset of the set of downstream nodes, where the downstream power consumption is attributable to power switching associated with the node, and where the downstream power consumption depends, at least in part, on the activity factor and the transmission factor. While the above method is described being stored on a computer-readable medium, it is to be appreciated that other example methods described herein can also be stored on a computer-readable medium.

In one example, data structures may be constructed that facilitate storing data on a computer-readable medium and/or in a data store. Thus, in one example, a computer-readable medium may store a data structure that includes a first field that is configured to store data representing an activity factor associated with a node and a second field that is configured to store data representing a transmission factor relating the node to a downstream node on a causal power switching basis. With this “raw” data available, the data structure may also include a third field that is configured to store data representing a downstream power attributable to the node, where the downstream power is derived from the data stored in the first and second field. While three fields are described, it is to be appreciated that a greater and/or lesser number of fields could be employed.

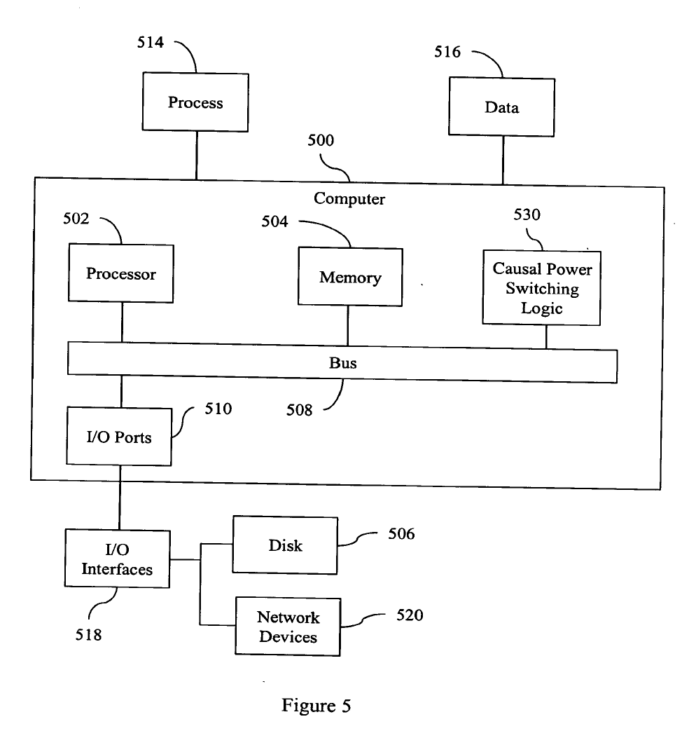

FIG. 5 illustrates a computer 500 that includes a processor 502, a memory 504, and input/output ports 510 operably connected by a bus 508. In one example, the computer 500 may include a causal power switching logic 530 configured to facilitate activity factor based downstream power consumption analysis. Thus, the causal power switching logic 530, whether implemented in computer 500 as hardware, firmware, software, and/or a combination thereof may provide means for means for determining an activity factor for a node, means for determining a power consumption for the node and means for determining a transmission factor between the node and a set of downstream nodes. With the activity factor, power consumption, and transmission factor available, the causal power switching logic 530 may also provide means for determining a power consumption for a set of downstream nodes (e.g., the fanout) and means for determining a change in the power consumption for the set of downstream nodes. The change in power consumption for the set of downstream nodes may be determined as a result of reconfiguring the activity factor for the node.

The processor 502 can be a variety of various processors including dual microprocessor and other multi-processor architectures. The memory 504 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 506 may be operably connected to the computer 500 via, for example, an input/output interface (e.g., card, device) 518 and an input/output port 510. The disk 506 can include, but is not limited to, devices like a magnetic disk drive, a solid state disk drive, a floppy disk drive, a tape drive, a Zip drive, a flash memory card, and/or a memory stick. Furthermore, the disk 506 can include optical drives like a CD-ROM, a CD recordable drive (CD-R drive), a CD rewriteable drive (CD-RW drive), and/or a digital video ROM drive (DVD ROM). The memory 504 can store processes 514 and/or data 516, for example. The disk 506 and/or memory 504 can store an operating system that controls and allocates resources of the computer 500.

The bus 508 can be a single internal bus interconnect architecture and/or other bus or mesh architectures. While a single bus is illustrated, it is to be appreciated that computer 500 may communicate with various devices, logics, and peripherals using other busses that are not illustrated (e.g., PCIE, SATA, Infiniband, 1394, USB, Ethernet). The bus 508 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 500 may interact with input/output devices via i/o interfaces 518 and input/output ports 510. Input/output devices can include, but are not limited to, a keyboard, a microphone, a pointing and selection device, cameras, video cards, displays, disk 506, network devices 520, and the like. The input/output ports 510 can include but are not limited to, serial ports, parallel ports, and USB ports.

The computer 500 can operate in a network environment and thus may be connected to network devices 520 via the i/o interfaces 518, and/or the i/o ports 510. Through the network devices 520, the computer 500 may interact with a network. Through the network, the computer 500 may be logically connected to remote computers. The networks with which the computer 500 may interact include, but are not limited to, a local area network (LAN), a wide area network (WAN), and other networks. The network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 520 can connect to WAN technologies including, but not limited to, point to point links, circuit switching networks like integrated services digital networks (ISDN), packet switching networks, and digital subscriber lines (DSL).

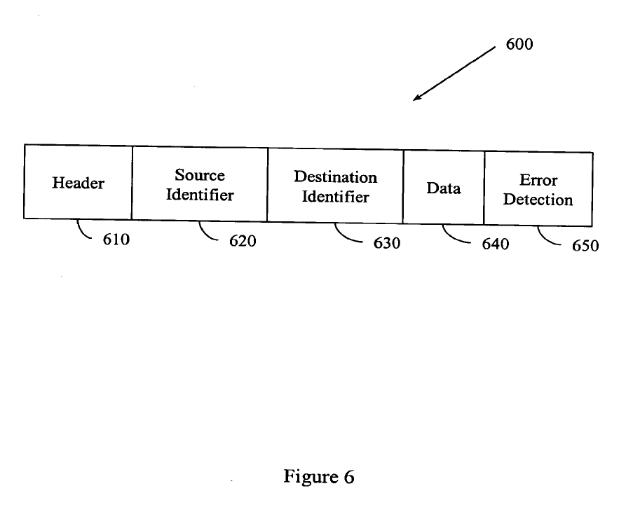

Referring now to FIG. 6, information can be transmitted between various computer components and/or logics associated with analyzing a portion of a circuit using a causal power switching based approach as described herein via a data packet 600. The data packet 600 includes a header field 610 that includes information like the length and type of packet. A source identifier 620 follows the header field 610 and includes, for example, an address of the computer component and/or logic from which the packet 600 originated. Following the source identifier 620, the packet 600 includes a destination identifier 630 that holds, for example, an address of the computer component and/or logic to which the packet 600 is ultimately destined. Source and destination identifiers can be, for example, a globally unique identifier (GUID), a uniform resource locator (URLs), a path name, and the like. The data field 640 in the packet 600 includes various information intended for the receiver and/or logic. The data packet 600 ends with an error detecting and/or correcting field 650 whereby a computer component and/or logic can determine if it has property received the packet 600. While five fields are illustrated in a certain order, it is to be appreciated that a greater and/or lesser number of fields arranged in different orders can be present in example data packets. Thus, data packet 600 may be used to transmit causal power switching analysis data to a circuit design system.

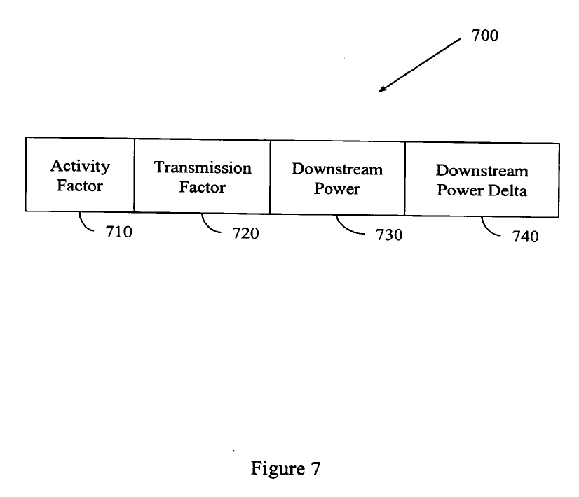

FIG. 7 is a schematic illustration of sub-fields 700 within the data field 640 (FIG. 6). The subfields 700 discussed are merely exemplary and it is to be appreciated that a greater and/or lesser number of sub-fields could be employed with various types of data germane to analyzing a portion of a circuit using a causal power switching based approach. The sub-fields 700 include a first field 710 that holds, for example, an activity factor data. The sub-fields 700 may also include a second field 720 that stores a transmission factor data, a third field 730 that stores a downstream power data, and a fourth field 740 that stores a downstream power delta data computed from activity factor data stored in the first field and transmission factor data stored in the second field. The downstream power delta data may represent, for example, the difference in the downstream power consumption attributable to a first upstream node and a replacement for that upstream node.

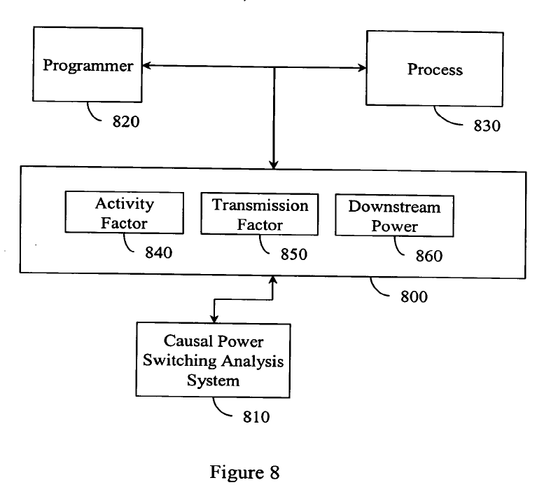

Referring now to FIG. 8, an application programming interface (API) 800 is illustrated providing access to a system 810 for analyzing a portion of a circuit using a causal power switching based approach. The API 800 can be employed, for example, by a programmer 820 and/or a process 830 to gain access to processing performed by the system 810. For example, a programmer 820 can write a program to access the system 810 (e.g., invoke its operation, monitor its operation, control its operation) where writing the program is facilitated by the presence of the API 800. Rather than programmer 820 having to understand the internals of the system 810, the programmer 820 merely has to learn the interface to the system 810. This facilitates encapsulating the functionality of the system 810 while exposing that functionality.

Similarly, the API 800 can be employed to provide data values to the system 810 and/or retrieve data values from the system 810. For example, a process 830 that acquires activity factor data can provide that data to the system 810 via the API 800 by, for example, using a call provided in the API 800. In one example, a set of application programming interfaces can be stored on a computer-readable medium. The interfaces can be employed by a programmer, computer component, logic, and so on to gain access to a system 810 for analyzing a portion of a circuit using a causal power switching based approach. The interfaces can include, but are not limited to, a first interface 840 that communicates an activity factor data, a second interface 850 that communicates a transmission factor data, and a third interface 860 that communicates a downstream power data derived from the activity factor data and the transmission factor data.

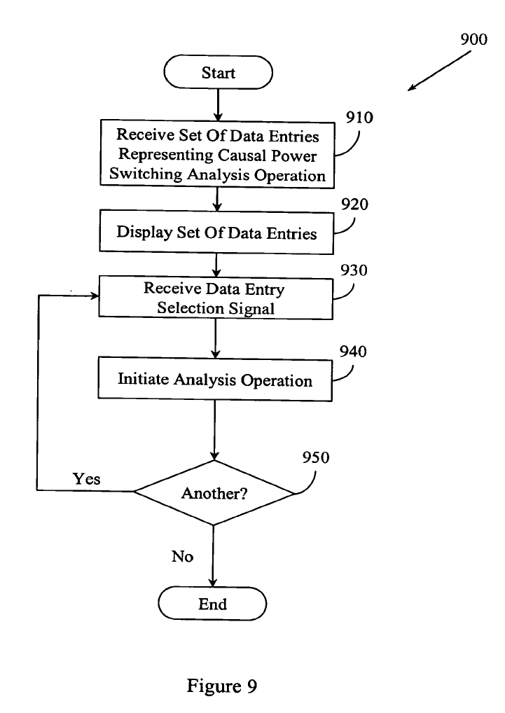

FIG. 9 illustrates an example method 900 associated with causal power switching based analysis of a node in a CMOS circuit operations and a graphical user interface. The method 900 may be performed in a computer system having a graphical user interface that includes a display and a selection device. The method 900 may include providing and selecting from a set of data entries on the display. Thus, in one example, the method 900 may include, at 910, retrieving a set of data entries, where a data entry represents a decision relating to causal power switching based analysis of a node in a CMOS circuit. The method 900 may also include, at 920, displaying the set of data entries on the display and, at 930, receiving a data entry selection signal indicative of the selection device selecting a selected data entry. The data entry selection signal may be received in response to, for example, a mouse click, a key press, a voice command, and so on. At 940, in response to the data entry selection signal, the method 900 may include initiating a causal power switching based analysis operation associated with the selected data entry. In one example, a determination is made at 950 concerning whether another data entry selection signal is to be processed. If the determination is Yes, then processing returns to 930, otherwise, method 900 may complete.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A system, comprising:
an activity factor logic configured to determine an activity factor for a first node, where the activity factor relates an input activity for the first node to an output activity for the first node;
a transmission factor logic configured to determine a transmission factor for the first node, where the transmission factor describes a degree of causal power switching between the first node and a second node; and
a downstream power logic operably connected to the activity factor logic or the transmission factor logic, the downstream power logic being configured to determine a power consumption amount for the second node, where the power consumption amount depends, at least in part, on the activity factor and the transmission factor.

2. The system of claim 1, including a user interface logic operably connected to the activity factor logic, the user interface logic being configured to facilitate selecting a node for which the activity factor logic will determine an activity factor and for which a downstream fanout power consumption will be determined.

3. The system of claim 1, where the activity factor logic determines the activity factor for the first node by analyzing the results of a circuit simulation that includes the first node, where the circuit simulation includes presenting a set of input vectors to the first node, acquiring a set of output vectors produced by the circuit simulation in response to the set of input vectors being presented to the first node, and analyzing the output vectors.

4. The system of claim 1, where the power consumption amount is determined according to:
P=C×V²×F×AF×TF
where P=power consumption amount,
C=capacitance,
V=voltage,
F=switching frequency,
AF=activity factor, and
TF=transmission factor.

5. The system of claim 4, where the transmission factor (TF) equals 1.0.

6. The system of claim 4, where the transmission factor (TF) is less than or greater than 1.0.

7. The system of claim 1, including a node replacement logic configured to select a node to be reconfigured in a circuit including the first node and the second node based, at least in part, on one or more of, the activity factor, the power consumption amount, and the potential change in the power consumption amount that is attributable to reconfiguring the first node by changing its activity factor.

8. The system of claim 1, where a fanout power consumption amount attributable to the first node is determined by traversing a set of nodes in a netlist where the nodes are downstream from the first node, calculating a power consumption amount for nodes in the netlist, and summing the calculated power consumption amounts.

9. The system of claim 8, where the fanout power consumption amount is determined for one or more of, an individual member of the set of nodes in the netlist, a subset of nodes representing a fanout level, and the entire set of nodes in the netlist.

10. A method, comprising:
acquiring an activity factor for a node in a digital CMOS circuit;
acquiring a transmission factor that models a causal power switching relationship between the node and a set of downstream nodes related to the node; and
calculating a first downstream power consumption for a subset of the set of downstream nodes, where the downstream power consumption is attributable to power switching associated with the node, and where the downstream power consumption depends, at least in part, on the activity factor and the transmission factor.

11. The method of claim 10, including:
selecting a node in the digital CMOS circuit for reconfiguration based on the availability of a replacement node having an activity factor different than the activity factor associated with the node;
calculating a second downstream power consumption for the subset of downstream nodes using the replacement node; and
selectively replacing the node in the digital CMOS circuit with the replacement node based on a relationship between the first downstream power consumption and the second downstream power consumption.

12. The method of claim 10, where acquiring the activity factor for the node in the digital CMOS circuit includes computing the activity factor by:
presenting a set of input data values to a circuit simulation that includes the node;
analyzing a set of output data values produced in response to the set of input data values being presented to the node in the circuit simulation; and
determining the activity factor as a relationship between the set of input data values and the set of output data values.

13. The method of claim 12, where calculating the downstream power consumption includes:
identifying a set of nodes located in a downstream fanout associated with the node;
calculating a power consumption for a subset of the set of nodes; and
aggregating the power consumptions calculated for the subset.

14. The method of claim 13, where the subset comprises one or more of, an individual member of the set of nodes, a subset of nodes representing a fanout level, and the entire set of nodes.

15. The method of claim 13, where the power consumption for a member of the set of nodes is calculated according to:
P=C×V²×F×AF×TF
where P=power consumption amount,
C=capacitance,
V=voltage,
F=switching frequency,
AF=activity factor, and
TF=transmission factor, where TF equals 1.0.

16. The method of claim 13, where the power consumption for a member of the set of nodes is calculated according to:
P=C×V²×F×AF×TF
where P=power consumption amount
C=capacitance,
V=voltage,
F=switching frequency,
AF=activity factor, and
TF=transmission factor, where TF is less than or greater than 1.0.

17. The method of claim 10, including selecting a node for causal power switching related activity factor analysis based on one or more of, an input received via a user interface, and an input received from an artificial intelligence logic.

18. The method of claim 10, where the downstream power consumption is attributable to power switching associated with the node, and where the downstream power consumption depends, at least in part, on changing the transmission factor between the node and a subset of the set of downstream nodes.

19. A computer-readable medium storing processor executable instructions operable to perform a method, the method comprising:
acquiring an activity factor for a node in a circuit;
acquiring a transmission factor that models a causal power switching relationship between the node and a set of downstream nodes related to the node; and
calculating a first downstream power consumption for a subset of the set of downstream nodes, where the downstream power consumption is attributable to power switching associated with the node, and where the downstream power consumption depends, at least in part, on the activity factor and the transmission factor.

20. A system, comprising:
means for determining an activity factor for a node;
means for determining a power consumption for the node;
means for determining a transmission factor between the node and a set of downstream nodes;
means for determining a power consumption for the set of downstream nodes; and
means for determining a change in the power consumption for the set of downstream nodes, where the change in power consumption for the set of downstream nodes is caused by reconfiguring the activity factor for the node.

21. In a computer system having a graphical user interface comprising a display and a selection device, a method of providing and selecting from a set of data entries on the display, the method comprising:
retrieving a set of data entries, where a data entry represents a decision relating to causal power switching based analysis of a node in a CMOS circuit;
displaying the set of data entries on the display;
receiving a data entry selection signal indicative of the selection device selecting a selected data entry; and
in response to the data entry selection signal, initiating a causal power switching based analysis operation associated with the selected data entry.

22. A data packet for transmitting causal power switching analysis data to a circuit design system, comprising:
a first field that stores an activity factor data;
a second field that stores a transmission factor data;
a third field that stores a downstream power data computed from data stored in the first and second fields; and
a fourth field that stores a downstream power delta data computed from data stored in the first and second fields.

23. A computer-readable medium having stored thereon a data structure comprising:
a first field configured to store data representing an activity factor associated with a node;
a second field configured to store data representing a transmission factor relating the node to a downstream node on a causal power switching basis; and
a third field configured to store data representing a downstream power attributable to the node, where the downstream power is derived from the data stored in the first and second field.

24. A set of application programming interfaces embodied on a computer-readable medium for execution by a computer component in conjunction with activity factor based circuit design, comprising:
a first interface for communicating an activity factor data;
a second interface for communicating a transmission factor data; and
a third interface for communicating a downstream power data, where the downstream power data is derived, at least in part, from the activity factor data and the transmission factor data.
